(19) United States
(12) Patent Application Publication
(10) Pub. No.: US 2025/0178582 A1
(43) Pub. Date: Jun. 5, 2025

(54) AI-Based Traction Control System Using Real-Time RPM Analysis

(71) Applicant: Logan Locke Beckwith, IV, Homer, MI (US)

(72) Inventor: Logan Locke Beckwith, IV, Homer, MI (US)

(21) Appl. No.: 19/048,752

(22) Filed: Feb. 7, 2025

(51) Int. Cl. B60W 10/06; B60W 50/00; G06N 3/04; G06N 3/092

(52) U.S. Cl. CPC B60W 10/06; B60W 50/00; G06N 3/04; G06N 3/092; B60W 2050/0014; B60W 2050/0083; B60W 2300/28; B60W 2520/26; B60W 2556/10; B60W 2556/20

(57) ABSTRACT

An AI-driven traction control system for race cars that dynamically adjusts ignition timing based on real-time RPM signal analysis. The system uses machine learning to continuously refine slip detection, eliminating the need for predefined slip thresholds. Unlike traditional methods relying on acceleration comparisons or cylinder deactivation, this system modifies ignition timing incrementally to maintain traction while maximizing power delivery. The AI model adapts based on real-world race conditions, making the system self-learning and fully autonomous. The invention applies to performance vehicles with MSD ignition systems or similar RPM-based signal inputs.

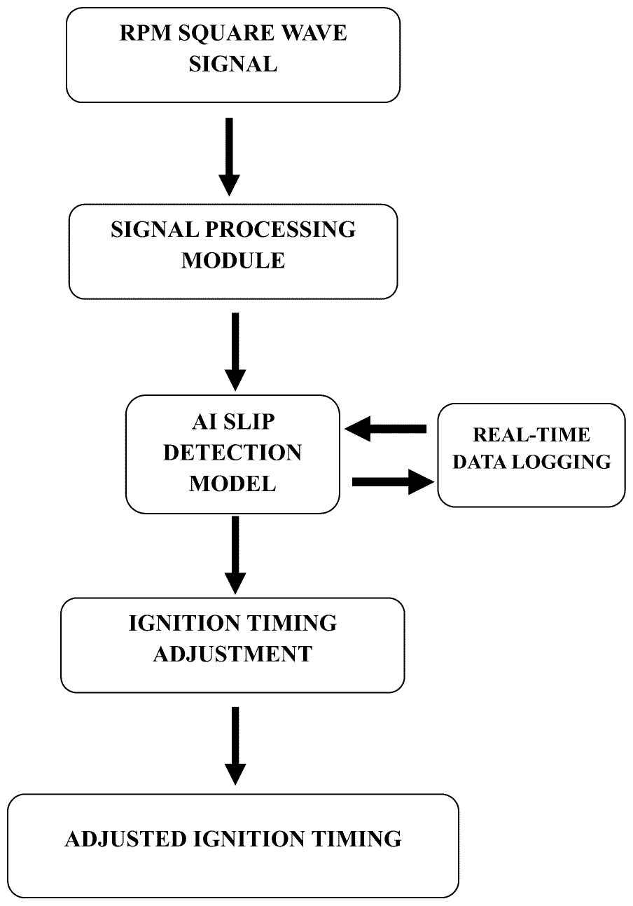

### FIELD OF THE INVENTION

The present invention relates to traction control systems for high-performance vehicles, specifically an AI-driven system that dynamically adjusts ignition timing based on real-time RPM signal analysis to predict and prevent wheel slip.

### BACKGROUND OF THE INVENTION

Traditional traction control systems rely on predefined acceleration thresholds, wheel speed sensors, or crude power-cutting methods such as cylinder deactivation or fuel-cut strategies. These approaches often lack adaptability, failing to optimize traction dynamically based on real-time conditions.

This invention introduces an AI-driven traction control system that continuously learns from real-world RPM fluctuations and modifies ignition timing in real time to maintain maximum traction without unnecessary power loss.

### SUMMARY OF THE INVENTION

The AI-based traction control system utilizes machine learning algorithms to analyze real-time engine RPM data. By detecting rapid fluctuations indicative of wheel slip, the system makes real-time adjustments to ignition timing, allowing for improved traction and enhanced performance.

The system is designed to work exclusively with the vehicle's ignition RPM square wave signal, eliminating the need for additional sensors. The embedded AI model continuously refines itself using past slip conditions, ensuring optimal performance for different track conditions.

1. A traction control system for a vehicle, comprising:
a computing unit configured to receive a real-time RPM square wave signal from a vehicle's ignition system;
a machine learning model stored in a non-transitory computer-readable medium, wherein the model is trained to detect RPM fluctuations indicative of wheel slip;
a signal processing module configured to continuously analyze RPM patterns for slip prediction;
an ignition timing adjustment module configured to dynamically modify ignition timing when the system detects a probability of slip;
a real-time data logging module configured to refine the AI model based on past slip conditions;
wherein the computing unit continuously updates the slip detection model to improve performance and adapt to different track conditions.

2. The system of claim 1, wherein:
the computing unit is an embedded processor, a Raspberry Pi, a Jetson Nano, or an equivalent microcontroller;
the machine learning model uses a convolutional neural network (CNN) or a recurrent neural network (RNN) for pattern recognition of RPM signals.

3. The system of claim 1, wherein:
the slip detection is performed without predefined acceleration thresholds, instead relying on historical and real-time RPM fluctuation trends.

4. The system of claim 1, wherein:
the ignition timing adjustment module is configured to retard ignition timing incrementally based on the AI-determined slip probability;
the system does not use cylinder deactivation or fuel cut-off mechanisms.

5. The system of claim 1, wherein:
the real-time data logging module stores prior detected slip conditions to continuously retrain the AI model;
the system improves traction control performance without requiring manual configuration of slip thresholds by the user.

6. The system of claim 1, wherein:
the computing unit samples the RPM signal at a high frequency to detect rapid fluctuations;
the AI model assigns a confidence score to potential slip events, filtering out false positives.

7. A method for preventing wheel slip in a vehicle, comprising:
receiving a real-time RPM signal from the vehicle's ignition system;
extracting key signal characteristics using a signal processing module;
applying a trained AI model to detect potential wheel slip;
adjusting ignition timing dynamically to counteract detected slip;
continuously updating the AI model based on logged race conditions.

8. The method of claim 7, wherein:
the AI model continuously improves its accuracy through reinforcement learning;
the computing unit applies adaptive control logic to fine-tune ignition adjustments.

9. The method of claim 7, wherein:
slip detection is performed without reliance on static RPM thresholds or acceleration-based slip calculations.

10. A vehicle comprising the system of claim 1, wherein the system is implemented in a:
race car with an MSD ignition system;
performance vehicle requiring adaptive traction control.
